(19) United States
(12) Patent Application Publication
(10) Pub. No.: US 2023/0106396 A1
(43) Pub. Date: Apr. 6, 2023

(54) METHODS FOR SPIRITS REFINING

(71) Applicant: BESPOKEN SPIRITS, INC., Menlo Park, CA (US)

(72) Inventors: Martin JANOUSEK, Mountain View, CA (US); Jordan SPITZER, San Mateo, CA (US); Arne BALLANTINE, Palo Alto, CA (US); Sanjiv KAPOOR, San Jose, CA (US); Parke BALLANTINE, Palo Alto, CA (US); Stuart AARON, Los Altos, CA (US)

(21) Appl. No.: 17/905,558

(22) PCT Filed: Mar. 4, 2021
(86) PCT No.: PCT/US21/20780

§ 371 Date: Sep. 2, 2022

Related U.S. Application Data
(60) Provisional application No. 62/985,706, filed on Mar. 5, 2020.

(51) Int. Cl. C12G 3/07

(52) U.S. Cl. CPC C12G 3/07; A47J 31/40

(57) ABSTRACT

Systems, methods, and devices of the various embodiments may enable maturing of spirits and other products. Various embodiments may be suitable for use in spirits refining businesses.

### RELATED APPLICATIONS

This application claims the benefit of priority to U.S. Provisional Application No. 62/985,706 entitled “Methods for Spirits Refining” filed on Mar. 5, 2020, the entire contents of which are hereby incorporated by reference for all purposes.

### BACKGROUND

Standard processes for maturing spirits or other products typically involve the distilled spirits or other products being placed into a barrel, such as an oak barrel, and kept in contact with the inner surface of that barrel for a period of time. In these standard processes, the barrel itself may be treated, such as by charring, in an to attempt to deliver a desired flavor to the spirits or other products.

Some attempts have been made to accelerate the maturing of sprits such that maturation occurs faster than in the standard processes. However, these attempts have not been shown to consistently accelerate the maturation process such that a controlled result may be achieved.

### SUMMARY

Systems, methods, and devices of the various embodiments may enable maturing of spirits and other products. Various embodiments may be suitable for use in spirits refining businesses.

Various embodiments may enable creation of a dispersion of spirit flavors from an input batch of spirits. In various embodiments, used micro-staves may be reused and/or resold for other purposes. Various embodiments may enable spirits products to be upgraded for higher value or better marketability. Various embodiments may enable taste fingerprinting. Various embodiments include small scale implementation of rapid spirits maturing processes. Various embodiments include broad implementations of rapid spirits maturing processes. Various embodiments may be used in barrel-based or fermentation-based rapid spirits maturing processes and products. Various embodiments enable rapid maturing of non-spirits products that are typically aged in barrels or rapid creation of non-spirits products that require fermentation.

Various embodiments may include a method comprising creating a dispersion of spirit flavors from a single input batch of spirits. Various embodiments may include a method comprising reusing micro-staves already used in rapid spirits maturing for non-rapid spirits maturing purposes. Various embodiments may include a method comprising using rapid spirits maturing to upgrade spirits to a higher value spirits or better marketability spirits. Various embodiments may include a method for taste fingerprinting of a user. Various embodiments may include a method comprising using a rapid spirits maturing processor in a distillery. Various embodiments may include a method comprising using a rapid spirits maturing processor on a farm. Various embodiments may include a method comprising using a rapid maturing processor for flavoring, aging, creating, and/or refining any typically barrel-based and/or fermentation-based product.

Various embodiments may include a mobile rapid spirits maturing processor.

Various embodiments may include a capsule including a spirits concentrate that when blended with a liquid creates a desired end product.

Various embodiments may include a wood concentrate that when diluted with water or neutral spirits produces a flavored spirit.

Various embodiments may include a beverage dispensing system in which water or neutral spirits is diluted through a wood concentrate to output flavored spirits.

Various embodiments may include a maturation unit designed for onsite use, for example in hotels, in bars, at home, etc., as described herein.

### BRIEF DESCRIPTION OF THE DRAWINGS

The accompanying drawings, which are incorporated herein and constitute part of this specification, illustrate example aspects of the claims, and together with the general description given above and the detailed description given below, serve to explain the features of the claims.

FIG. 1A is a block diagram illustrating aspects of a rapid spirits maturing processor according to various embodiments.

FIG. 1B is a block diagram illustrating aspects of a mobile rapid spirits maturing processor according to various embodiments.

FIG. 2A is a block diagram illustrating an example of a rapid spirits maturing processor in use in a distillery in accordance with various embodiments.

FIG. 2B is a block diagram illustrating an example of a rapid spirits maturing processor in use on a farm in accordance with various embodiments.

FIGS. 3A-3C are block diagrams illustrating aspects of capsules in accordance with various embodiments.

FIGS. 3D and 3E are block diagrams illustrating aspects of maturation units designed for onsite use in accordance with various embodiments.

FIG. 4 is a block diagram illustrating aspects of a beverage dispensing system according to various embodiments.

FIGS. 5A-5E are process flow diagrams illustrating methods according to various embodiments.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

As used herein the term “matured” may refer to spirits that have been transitioned from raw (or unrefined) spirits toward a state having one or more selected profile characteristics, such as aroma, color, flavor, etc. Such transition may be referred to as “maturation” or “maturing”. Typically, such maturation of spirits has been achieved by typical barrel-based aging processes. Matured spirits may also sometimes be referred to as “aged spirits.” As discussed herein, a matured spirit (or maturation or maturing) may be achieved in different time frames, and the term matured (or maturation or maturing) as used in reference to the various embodiments is not intended to imply any specific time period and is not intended to limit the various embodiments or claims to any specific time period.

As used herein, the term “micro-stave” may refer to a smaller piece of wood rendered (e.g., cut, chopped, chiseled, etc.) from a larger piece of wood such that resulting smaller piece of wood (i.e., the micro-stave) has cubic dimensions of equal to or less than approximately 20 mm×20 mm×100 cm, but greater than approximately 0.05 mm×0.05 mm×0.05 mm. Said another way, a micro-stave may be a processed (e.g., e.g., cut, chopped, chiseled, etc.) wood structure that completely fits within a rectangular volume that is 20 mm×20 mm×100 cm while not completely fitting within a rectangular volume that is 0.09 mm×0.09 mm×0.09 mm. Micros-staves may be rendered (e.g., cut, chopped, chiseled, etc.) from a larger piece of wood such that the volume and surface area of the wood piece that is the micro-stave is controlled to achieve a selected volume and surface area thereby enabling controlled and uniform extraction of the wood components by a spirit. While referred to herein using the term “micro” as part of “micro-stave” the term “micro” is not used in its metric system prefix meaning as part of “micro-stave”, but is rather a descriptor indicating that the “micro-staves” as described herein are smaller than staves used in typical wine or spirit barrels which are often on the order of 10 mm×60 mm×1000 mm or larger.

As used herein, the term “toasted” refers to a state of a wood product, such as a micro-stave, in which the wood product has been exposed to heat thereby causing thermal decomposition of the cellulose, hemicellulose and lignin in the wood forming the wood product without any resulting visible char accumulation on the external surface of the wood. Toasted wood products may have been heated such that some decomposition of the wood surface occurred without combustion reactions at the surface of the wood occurring to result in visible carbon residues (e.g., char layers). Toasting as described herein may be performed such that the entire volume of the wood is transformed and decomposed uniformly. Toasting may be done in an oven and may take a time period from minutes to hours to achieve a toasted state of a wood product.

As used herein, the term “charred” refers to a state of a wood product, such as a micro-stave, in which the wood product has been exposed to heat thereby causing thermal decomposition of the cellulose, hemicellulose and lignin in the wood to at least a point where visible char accumulates on the external surface of the wood. Charred wood products may have been heated such that some combustion reactions occurred at the surface of the wood resulting in visible carbon residues (e.g., char layers). Such resulting visible carbon residues (e.g., char layers) may be as thin as only a few microns (e.g., 2 microns) thick on the surface of the charred wood product. At least on surface of a wood product need not show visible carbon residues (e.g., charring) for the wood product to be considered a charred wood product, such that as long as a portion of the surface of the wood product is shows visible carbon residues (e.g., charring) the wood product is a charred wood product. In contrast, a toasted wood product may show no visible carbon residues (e.g., charring). Charring as described herein may be performed such that there is a gradient in wood transformation and decomposition due to very high temperatures at the surface that is being charred. Charring may be done with a heat source, such as a gas flame/torch, IR heater, etc., and may take a period of time from seconds to minutes to achieve a charred state of a wood product.

Various embodiments relate to the process of maturing spirits or other products wherein the distilled spirits or other products are placed into a container, such as an oak barrel, and kept in contact with the inner surface of that container, such as the oak barrel, for a period of time. In the standard process, the barrel may be treated with a process, such as charring, to deliver desired flavors to the product.

Some methods attempt to accelerate the maturing of sprits through various means. In one method, heating in the presence of light is used; in another method, ultrasonic energy is introduced. Methods of heating, steam injection or application of pressure may also be used. None of these methods have been shown to consistently accelerate the maturation process such that a controlled result may be achieved.

In various embodiments, a single feedstock may be used to create a dispersion of spirits products with different flavors. The single feedstock may be processed by a rapid spirits maturing process to achieve the different flavors. As used herein, a rapid spirits maturing process may be a process in which spirits are matured to achieve a desired flavor and/or taste within a period of less than 25 days, such as a period of 3-25 days or less, such as a period of 3-5 days or less, such as a period of hours, such as a period of less than 10 hours, such as a period of one hour.

Rapid spirits maturing according to various embodiments may be performed in a rapid spirits maturing processor. A rapid spirits maturing processor may be a device, system, or structure include a vessel (or container), such as a steel vessel, in which spirits, such as raw spirits or waste spirits, are rapidly matured to create matured spirits.

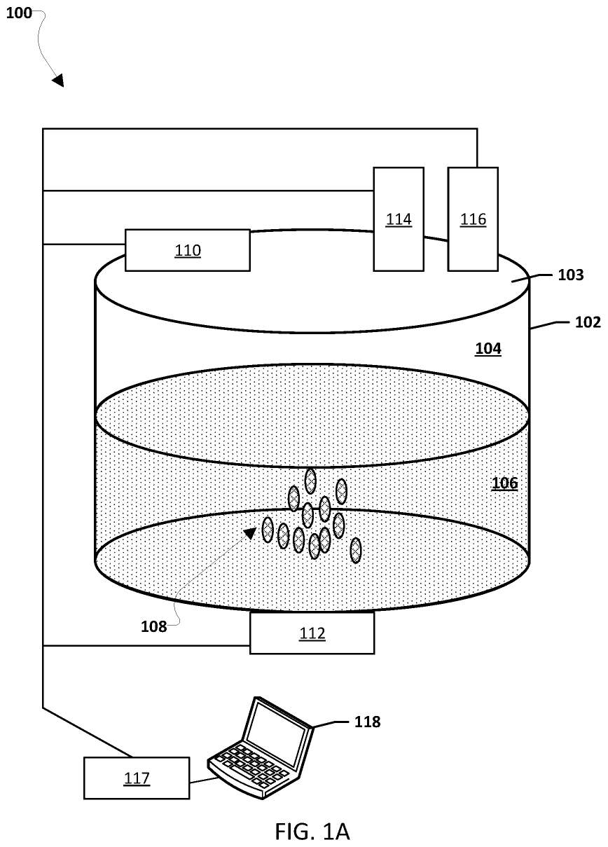

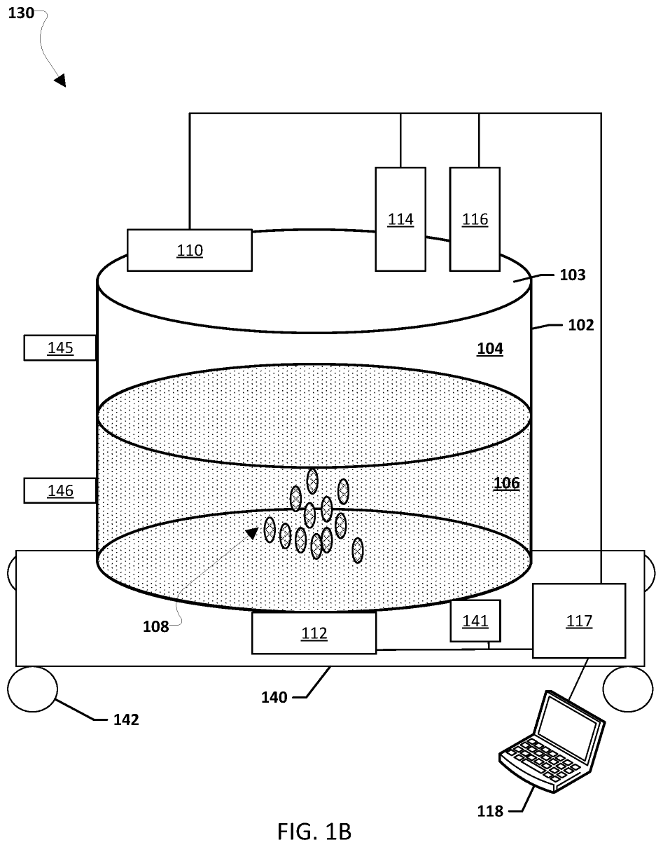

FIG. 1A illustrates a rapid spirits maturing processor 100 according to various embodiments. The rapid spirits maturing processor 100 may include a vessel 102 (or container), such as a steel vessel, in which spirits 106, such as raw spirits or waste spirits, are rapidly matured to create matured spirits. The vessel 102 of the rapid spirits maturing processor 100 may be sealed with a lid 103. The vessel 102 may include a volume of spirts 106 and a headspace 104 including a gas or gaseous mix (e.g., air, pure oxygen, a mix of air and added oxygen, nitrogen, etc.). The rapid spirits maturing processor 100 may include various systems, such as a heating system 112 (e.g., including one or more heating elements and temperature sensors, etc.) configured to control the temperature of the vessel 102 and/or spirits 106, an air delivery/removal system 114 (e.g., including one or more valves and gas (e.g., air, oxygen, etc.) configured to add and/or remove gas to/from the vessel 102 thereby controlling the gaseous mixture in the headspace 104 and/or the pressure within the vessel 102, a mixing system 116 (e.g., a motorized stirrer, etc.) configured to agitate the spirits 106 in the vessel 102, a filter system 110 (e.g., including an activated carbon filter, or other type filter) configured to capture vapors from the vessel 102, such as when the vessel 102 is in use and/or when opened, or other type systems. The various systems of the rapid spirits maturing processor 100 (e.g., the heating system 112, air delivery/removal system 114, mixing system 116, filter system 110, etc.) may be connected (e.g., by wired connections and/or wirelessly) to a controller 117 (e.g., a computer or dedicated control logic device or circuit) configured to monitor the conditions of the rapid spirits maturing processor 100 and/or to control the operations of the various systems of the rapid spirits maturing processor 100 (e.g., the heating system 112, air delivery/removal system 114, mixing system 116, filter system 110, etc.) The controller 117 may communicate, either directly or indirectly, with other systems/components in the rapid spirits maturing processor 100 and/or with one or more remote control terminals 118.

In some embodiments, one or more remote control terminals 118 may be connected to the controller 117 (e.g., by wired and/or wireless connections). The one or more remote control terminals 118 may be computing devices by which an operator may interact with the rapid spirits maturing processor 100. Alternatively, or additionally, the controller 117 may include its own user interface (e.g., display and/or keypad, etc.) and an operator may directly interact with the controller 117 via the user interface.

In some implementations, micro-staves 108 may be added with the spirits 106 into the vessel 102 of the rapid spirits maturing processor 100 to achieve the rapid maturing and variables, such as temperature, pressure, air concentration, oxygen levels, etc., of the vessel 102 may be controlled to achieve the desired matured spirit 106 output. For example, the controller 117 may control the various systems of the rapid spirits maturing processor 100 (e.g., the heating system 112, air delivery/removal system 114, mixing system 116, filter system 110, etc.) to achieve selected temperatures, pressures, air concentrations, oxygen levels, etc., of the vessel 102 corresponding to a desired matured spirit 106 output as indicated by an operator via a remote control terminal 118 and/or user interface of the controller 117.

In various embodiments, micro-staves 108 may be un-toasted. Un-toasted micro-staves may be formed from wood that is seasoned (e.g., left to dry for a specific time, such as 6-48 months). Un-toasted micro-staves may not be toasted or charred. In various embodiments, micro-staves 108 may be toasted. Toasted micro-staves may be formed from wood that is toasted prior to forming the micro-staves. The wood may be seasoned or un-seasoned. In various embodiments, micro-staves 108 may be charred. Charred micro-staves may be formed by charring toasted micro-staves and/or by charring un-toasted micro-staves. In some implementations, the micro-staves 108 that may be added with the spirits 106 into the vessel 102 of the rapid spirits maturing processor 100 to achieve the rapid maturing and variables, such as temperature, pressure, air concentration, oxygen levels, etc., of the vessel may be toasted micro-staves, un-toasted micro-staves, and/or charred micro-staves.

FIG. 1B illustrates a mobile rapid spirits maturing processor 130 according to various embodiments. With reference to FIGS. 1A-1B, the mobile rapid spirits maturing processor 130 may be similar to rapid spirits maturing processor 100 except that the mobile rapid spirits maturing processor 130 may be configured to move from one location to another. For example, the mobile rapid spirits maturing processor 130 may be disposed on a platform 140 that includes wheels 142 enabling the mobile rapid spirits maturing processor 130 to be moved within a facility and/or from one facility to another facility. In various embodiments the mobile rapid spirits maturing processor 130, may be rapidly installed at a location, such as a distillery. The mobile rapid spirits maturing processor 130 may include one or more rapid plumbing connections 145 and 146, such as food grade quick connect fittings. For example, one rapid plumbing connection 146 may be configured to couple the vessel 102 of the mobile rapid spirits maturing processor 130 to a line for providing/receiving spirits. As another example, one rapid plumbing connection 145 may be configured to couple the vessel 102 of the mobile rapid spirits maturing processor 130 to a gas line (e.g., an air line, oxygen line, etc.). The mobile rapid spirits maturing processor 130 may include fault detection systems, such as a leak detection system 141 (e.g., a float sensor, liquid sensor, gas sensor, etc.) or other type fault detection system, to ensure that leakage causing loss of product or flammable gas hazard is not present prior to, or during, operation of the mobile rapid spirits maturing processor 130. The fault detection system may be connected to the controller 117 and may output a warning signal to the controller 117 in the event of a fault detection. The controller 117 and/or a remote control terminal 118 may output a warning indication to an operator in response to receiving the warning signal.

In various embodiments, a rapid spirits maturing processor (e.g., 100, 130, etc.) may be used to mature a starting batch of spirits 106 (e.g., an input batch) from a first state to a desired end state (e.g., a final batch).

Various embodiments may eliminate the so called “angel's share” (i.e., the evaporation during aging) from barrel aging is eliminated creating the advantage of eliminating the hazard of black mold formation within the facility and in neighboring properties. Embodiment rapid spirits maturing processes may occur in sealed vessels (e.g., vessel 102) and in combination with the short time, such as 3-4 day, 3-20 days, less than 25 day, etc., associated with rapid spirits processing, may create advantage in comparison to the use of wooden barrels that are subject to leakage and evaporation of ethanol over the years of the maturation process.

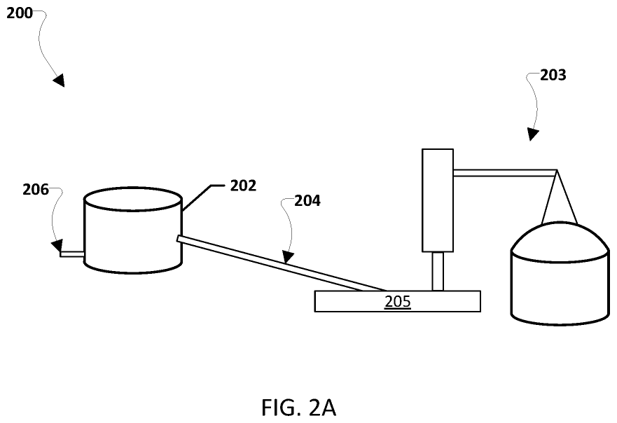

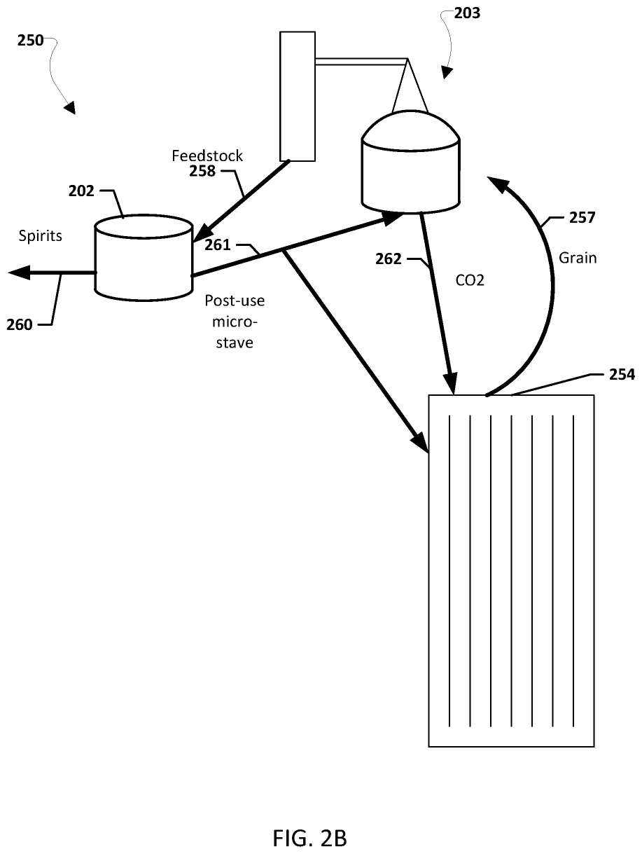

Various embodiments may include coupling the various rapid spirits maturing processes and rapid spirits maturing processors (i.e., devices configured to perform rapid spirits maturing processes) to a distillery. FIG. 2A illustrates an example of a rapid spirits maturing processor 202 in use in a distillery 200 in accordance with various embodiments. With reference to FIGS. 1A-2A, the rapid spirits maturing processor 202 may be any type rapid spirits maturing processor, such as rapid spirits maturing processor 100, 130, etc. Various embodiments may include coupling rapid spirits maturing processors directly to a distillery 200 wherein batches of product 205 (e.g., batches of distilled stock spirits from the distilling system 203) are placed into one or more staged rapid spirits maturing processors 202, such as via a piping system 204. The number of rapid spirits maturing processors 202 may be significant enough that the input and output of the rapid spirits maturing processors 202 becomes pseudo continuous. For example, one, two, three, four, five, six, seven, eight, nine, ten, or more than ten rapid spirits maturing processors 202 may be used in the distillery 200. Plumbing connections 206, such as connection 145 or other type connections, may output matured spirits from the rapid spirits maturing processor 202. Various embodiments may provide a distillery 200 tasting room, allowing consumers to taste what age tastes like with immediate feedstock.

Various embodiments may include vertical integration of various rapid spirits maturing processes and rapid sprit maturing processors to corn farms such that drying of corn is no longer needed, thus avoiding water waste. FIG. 2B is a block diagram illustrating an example of a rapid spirits maturing processor 202 in use on a farm 250 in accordance with various embodiments. With reference to FIGS. 1A-2B, the rapid spirits maturing processor 202 may be any type rapid spirits maturing processor, such as rapid spirits maturing processor 100, 130, etc. Various embodiments may include the overall method of conducting vertical farming of grain, local distillation, rapid spirits maturing processes for maturation and market dispersion from the same vertically integrated farm 250, and then post-use micro-stave wood consumption for power at the vertically integrated farm 250, with any generated carbon dioxide recycled back to the vertically integrated farm 250. Alternative embodiments include wherein a standard farm 250 is used in place of vertical farming, and regenerative farming methods are used to build the strength of the biome in the soil (e.g., soil in field 254). As one example of farm 250 and rapid spirits maturing processor 202 integration, FIG. 2B illustrates that in one step 257 grain from a field 254 of the farm 250 may be provided to the distilling system 203. In step 258, the resulting feedstock spirits from distilling the grain may be provided to the rapid spirits maturing processor 202. In step 260 matured spirits may be output from the rapid spirits maturing processor 202. In step 261 post-use micro-staves (e.g., micro-staves 108 after generation of a mature spirits) may be burned to provide heat for the distilling system 203 and/or recycled back to the field 254.

Various embodiments include small scale implementation of rapid spirits maturing processes. For example, the rapid spirits maturing processor 100, 130, etc., may be sized for onsite use, for example in hotels, in bars, at home, etc. Various embodiments may include small capsules which contain a concentrate of the spirits and blending these with water and or alcohol to create the desired end product at the point of use.

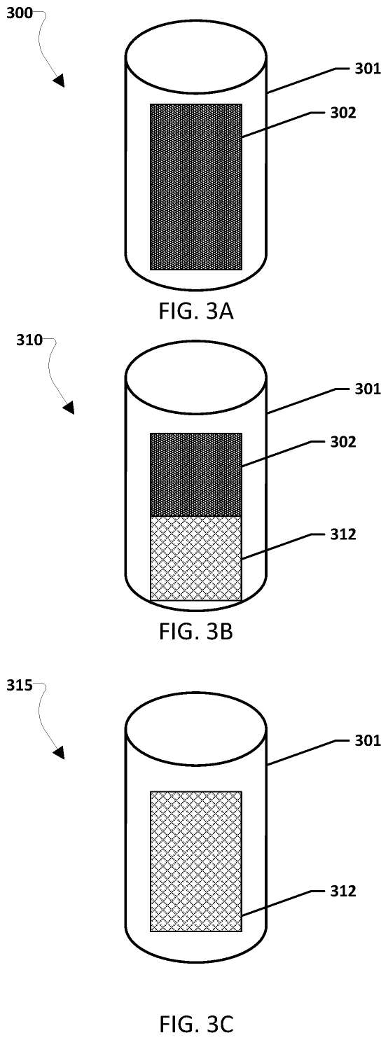

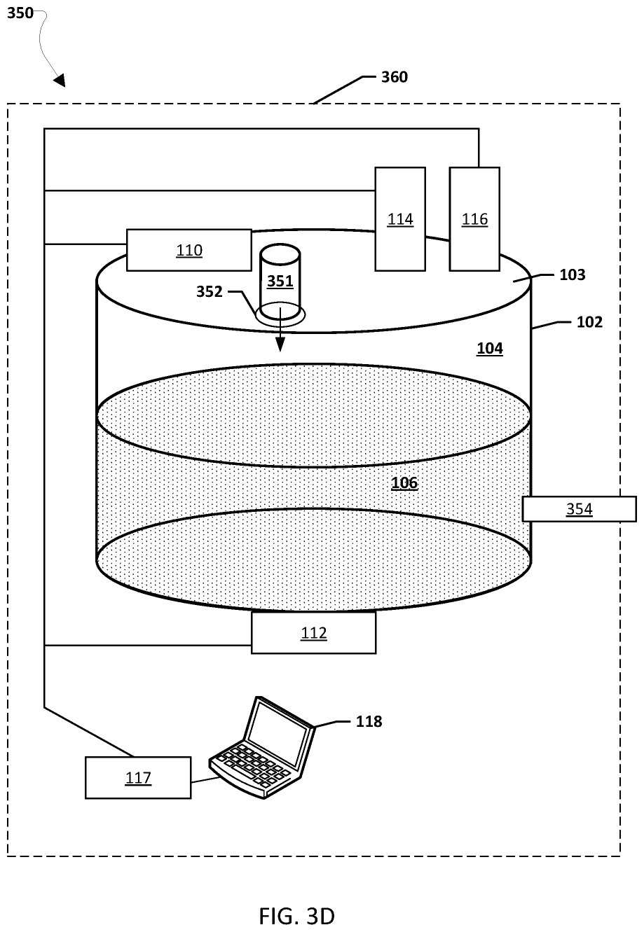

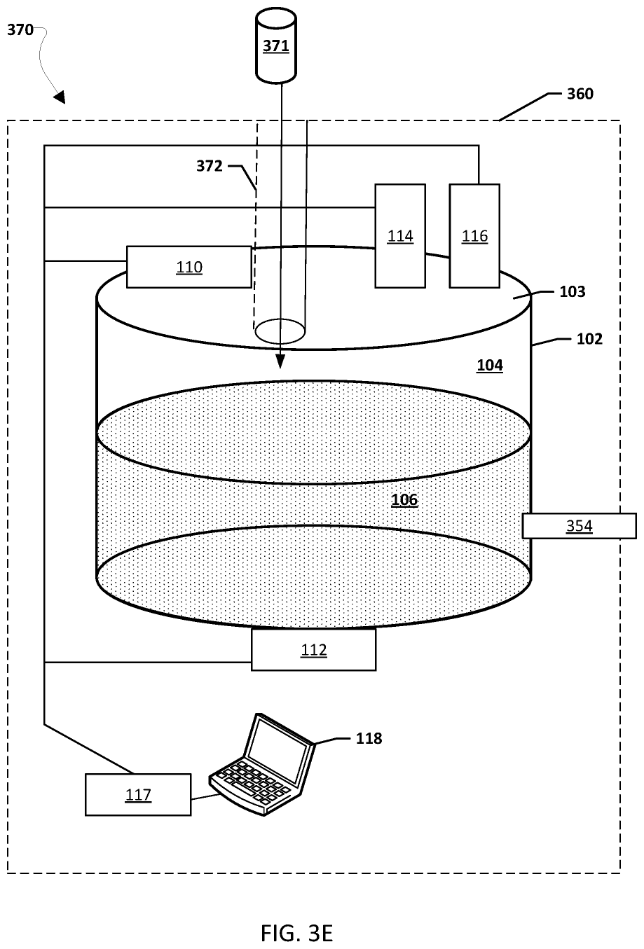

FIGS. 3A-3C illustrate example capsules (or containers) 300, 310, 315 in accordance with various embodiments. With reference to FIGS. 1A-3C, the capsule 300 of FIG. 3A may include an outer packaging 301, such as a plastic, paper, or other type packaging, encapsulating a wood concentrate 302. The capsule 310 of FIG. 3B may include an outer packaging 301 encapsulating a combination of wood concentrate 302 and liquid 312, such as spirits and/or water. The capsule 315 of FIG. 3B may include an outer packaging 301 encapsulating a liquid 312, such as spirits and/or water.

In various embodiments, wood concentrate 302 may be wood, such as micro-staves, that is un-toasted (e.g., un-toasted micro-staves). In various embodiments, wood concentrate 302 may be wood, such as micro-staves, that is toasted (e.g., toasted micro-staves). The wood concentrate 302 may be seasoned or un-seasoned. In various embodiments, wood concentrate 302 may be wood, such as micro-staves, that may be charred (e.g., charred micro-staves). In some embodiments, the wood concentrate 302 may be a formed from one or more types of wood, such as one or more types of micro-staves, that may be combinations of toasted, un-toasted, and/or charred wood (e.g., combinations of toasted micro-staves, un-toasted micro-staves, and/or charred micro-staves).

Various embodiments may provide a maturation unit designed for onsite use, for example in hotels, in bars, at home, etc. FIGS. 3D and 3E are block diagrams illustrating aspects of maturation units 350 and 370, respectively, designed for onsite use in accordance with various embodiments. With reference to FIGS. 1A-3E, for example, the maturation units 350 and 370 may be rapid spirits maturing processors, similar to rapid spirits maturing processors 100, 130 described above, and configured to operate using capsules (or containers), such as capsules 300, 310, 315 described above. The maturation units 350 and 370 may be a counter-top machine/appliance in some embodiments. The maturation units 350 and 370 may include a housing 360 enclosing the vessel 102 and other components of the rapid spirits maturing processors 100, 130

Wood and spirits may be sold and/or purchased for the unit in pre-filed capsules or containers (e.g., capsules 300, 310, and/or 315). FIG. 3D illustrates an embodiment in which the maturation unit 350 is configured such that the operator (e.g., customer/user) inserts pre-filed capsules 351 (e.g., capsules 300, 310, and/or 315) directly into the maturation unit 350, such as into a capsule receptacle 352 that opens the capsule to dispense the wood concentrate and/or liquid (e.g., spirits and/or water) into the vessel 102. FIG. 3E illustrates an embodiment in which the maturation unit 370 is configured such that the operator (e.g., customer/user) opens pre-filed capsules 371 (e.g., capsules 300, 310, and/or 315) pours the wood concentrate and/or liquid (e.g., spirits and/or water) from the capsules 371 through a delivery tube 372 in the housing 360 and into the vessel 102.

In various embodiments, the maturation unit 350, 370 may receive inputs that are similar to those described herein in relation to rapid spirits maturing processors for distillers (e.g., type of spirit and wood (e.g., micro-staves, chips, powder, etc.), temperature, time, selected recipe, etc.). In various embodiments, the maturation unit 350, 370 may output matured spirits, such as via a dispensing system 354 (e.g., dispensing port, tube, etc.). In various embodiments, the maturation unit 350, 370 may generate a spirit volume of 0.5 to 50 liters. In various embodiments, all the customer/user needs to do is insert the spirit and the wood (e.g., from the pre-filed capsules and/or by inserting the capsules themselves), select a program, and the maturation unit 350, 370 runs for a couple of hours to up to a couple of days to produce the spirit. The maturation unit 350, 370 may be a consumer/end user facing unit providing the process controls discussed above with relation to rapid spirits maturing processors 100, 130 (e.g., for temperature, time, pH, conductivity, stirring, etc.).

Various embodiments may include producing a wood concentrate using high wood to spirit volume ratios (e.g., 10 to 100) that can be diluted with water and/or neutral spirits (like a soda gun in a bar in a manner similar to a Coke® concentrate) to produce matured or flavored spirits on tap (rum, whiskey, etc.). This has an advantage in a large market for cocktail drinks. Various embodiments may include a beverage dispensing system in which water or neutral spirits is diluted through a wood concentrate to output flavored spirits.

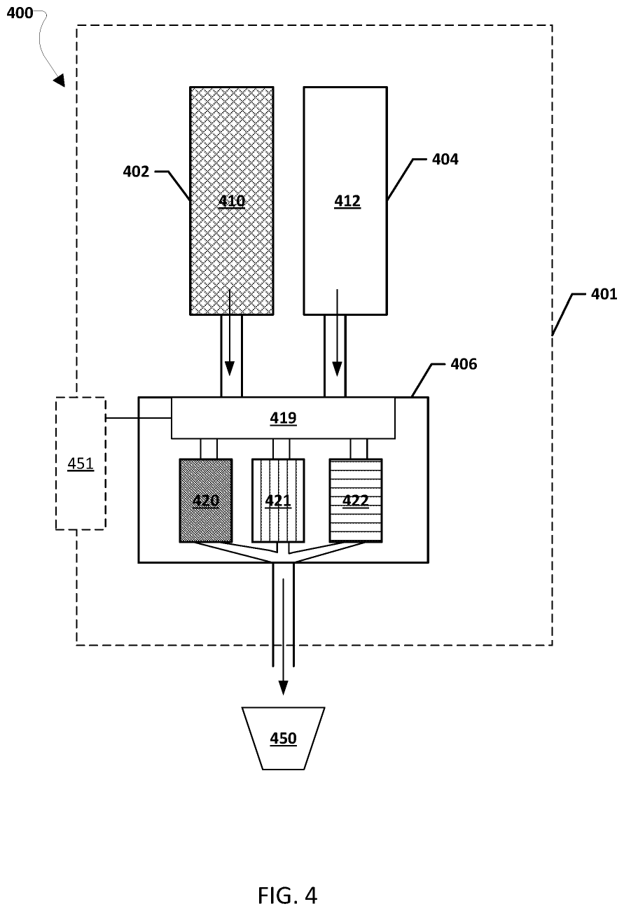

FIG. 4 is a block diagram illustrating aspects of a beverage dispensing system 400 according to various embodiments. With reference to FIGS. 1A-4, the beverage dispensing system 400 may be type of rapid spirits maturing processor, similar to rapid spirits maturing processors 100, 130, 202, the maturation units 350, 370, etc., described above. The system 400 may include a housing 401 encasing a neutral spirits chamber 402 and water chamber 404. The neutral spirits chamber 402 may be filed with neutral spirits 410 and fluidically connected to a dispensing unit 406. The water chamber 404 may be filed with water 412 and fluidically connected to the dispensing unit 406. The dispensing unit 406 may include a controllable mixing valve 419 configured to receive the neutral spirits 410 and/or water 412 from the neutral spirits chamber 402 and/or water chamber 404. The controllable mixing valve 419 may be configured to output a selected amount of neutral spirits 410 and/or water 412 to one or more wood concentrate chambers 420, 421, and/or 422. The wood concentrate chambers 420, 421, and/or 422 may be filled with different types of wood concentrate configured to produce matured or flavored spirits when the neutral spirits 410 and/or water 412 are run through the wood concentrate chambers 420, 421, and/or 422. For example, the wood concentrate chambers 420, 421, and/or 422 may be filed with wood concentrate similar to wood concentrate 302. A controller 451 may control the controllable mixing valve 419 according to inputs from a user to select the amount and/or mixture of neutral spirits 410 and/or water 412 sent to one or more of the wood concentrate chambers 420, 421, and/or 422 to produce matured or flavored spirits on tap (rum, whiskey, etc.) that may be dispensed into a container 450 (e.g., a cup, glass, etc.).

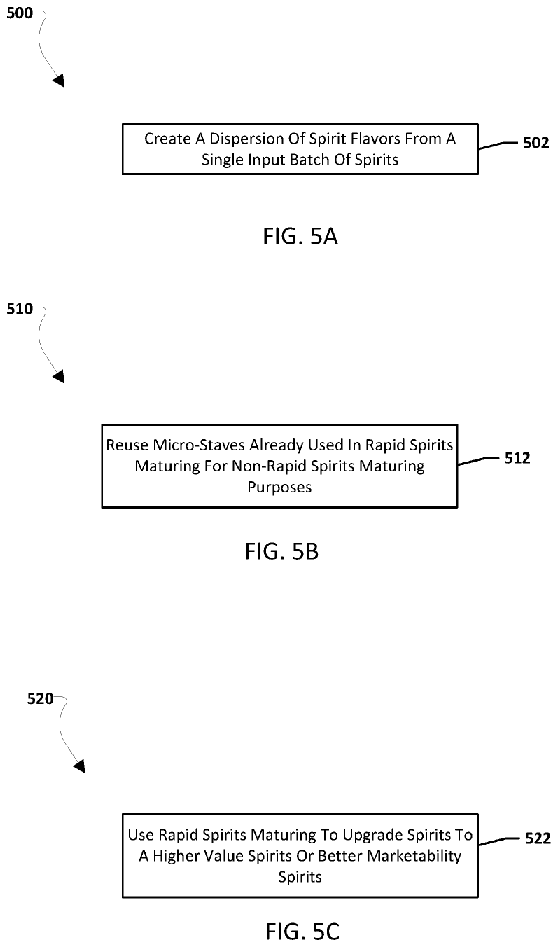

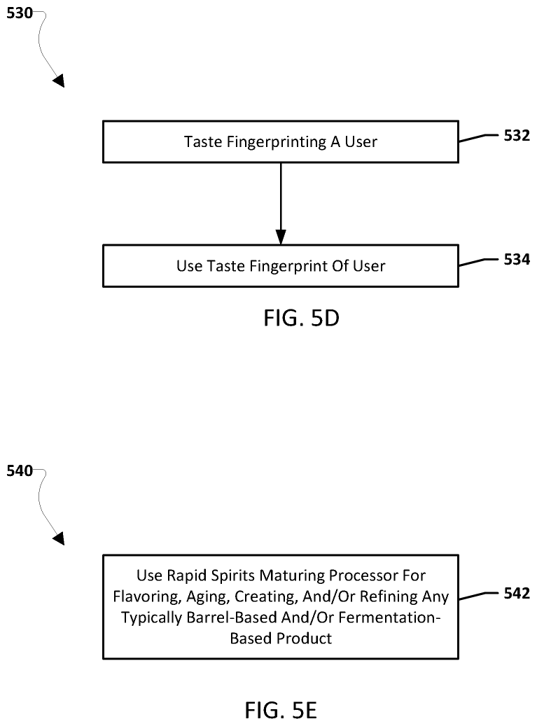

FIGS. 5A-5E illustrate embodiments methods 500, 510, 520, 530, and 540 related to spirits processing that may be performed according to various embodiments. In various embodiments, the operations of methods 500, 510, 520, 530, and/or 540 may be performed individually, and/or in conjunction with one another. For example, any one or more operations of methods 500, 510, 520, 530, and/or 540 may be performed in conjunction with any one or more of the other operations of methods 500, 510, 520, 530, and/or 540. In various embodiments, one or more of the operations of methods 500, 510, 520, 530, and/or 540 may be performed, at least in part, using one or more of the rapid spirits maturing processors 100, 130, 202, the maturation units 350, 370, and/or the beverage dispensing system 400 described above.

Various embodiments may include the creation of a dispersion of spirit flavors from an input batch of spirits that would yield normally only a single flavor using typical methods. FIG. 5A illustrates such a method 500 including creating a dispersion of spirit flavors from a single input batch of spirits in a step 502, for example using one or more of the rapid spirits maturing processors 100, 130, 202, the maturation units 350, 370, and/or the beverage dispensing system 400 described above. Various embodiments enable creating a dispersion of spirit flavors from an input batch that would normally yield only a single flavor.

Various embodiments may include tailoring a specific feedstock by regional tastes and season of the year, and by different regional taste or seasonal taste for different regions or times of the year causing the result of being able to market to multiple markets with a single feedstock.

Various embodiments may provide environmental advantages.

In various embodiments, used micro-staves may be reused and/or resold for other purposes. FIG. 5B illustrates such a method 510 including reusing micro-staves already used in rapid spirits maturing (e.g., micro-staves 108 used in rapid spirits maturing processors 100, 130, etc.) for non-rapid spirits maturing purposes in a step 512. For example, used micro-staves may be reused as fire starters for camping to create a recycled product from the processed micro-staves. Furthermore, the spirits in the micro-staves enable better fire starting and camping fire flavoring.

In various embodiments, the used micro-staves may be used to create custom toasted and/or charred wood chips which may be infused with liquids, such as bourbon, to create a desired, such as an optimized, flavored, etc., barbeque cooking result.

In various embodiments, post-use processing of the micro-staves may occur for a valuable end use, such as use for power generation (after catalytic combustion), use for BBQ food preparation, use as flavoring additives (e.g., whiskey infused wood staves for use in hot sauces), etc.

Various embodiments may enable spirits products to be upgraded for higher value or better marketability. FIG. 5C illustrates such a method 520 including using rapids spirits maturing to upgrade spirits to a higher value spirits or better marketability spirits in a step 522, for example using one or more of the rapid spirits maturing processors 100, 130, 202, the maturation units 350, 370, and/or the beverage dispensing system 400 described above. Various embodiments may include the method 520 of improving or recovering other types of alcoholic beverages using various rapid spirits maturing processes. Various embodiments may enable recovering bad wine and converting such bad wine to fortified wines, e.g., Sherry, Port, Madeira, or like products. Various embodiments may include taking an input of poor quality or poor taste spirits, stripping off all taste related contents via distillation and then recreating good flavor using various rapid spirits maturing processes. Various embodiments may include taking waste, or expired, beer adding spent grain as needed to increase amount of cogeners (which include fusel oil, aldehydes, furfural, esters, solids, tannins, and many uncharacterized compounds) and upgrading that product into whiskey with good flavor using distillation and various rapid spirits maturing processes. Various embodiments may include converting a neutral spirit, e.g., vodka, to matured spirits by: a) Charcoal filtration; b) Repeat distillation; c) Replacing any missing grainy flavor which could be missing by adding the appropriate esters; and d) Conducting a rapid spirits maturing process to achieve maturation. Various embodiments may enable the production of blended whiskey by using a minimum of 20% of straight whiskey and blending it with spirit processed using various rapid spirits maturing processes to improve color and flavor of the blended whiskey. Various embodiments may enable the improvement of the flavor of spirits by controlling the acid levels content and species before and during distillation.

Various embodiments may include creating custom spirits for the use of cooking based upon the intended flavors of the food items which are being prepared. Using various maturing processes to create the taste and flavors, chefs will then be able to have flavors which are specific to their requirements for cooking, whereas in the normal process chefs may only use spirits which are in standard production. Food items as examples may include specific egg-nog tailored spirits, cake specific spirits, etc. Various embodiments may include taking gourmet chef feedback to achieve the desired, e.g., optimum, flavor profile for a given chef, given restaurant or given food factory. Various embodiments may include a method including creating micro batches to evaluate the tastes of markets and rapidly determine the optimum taste for a given market

Various embodiments may enable taste fingerprinting. FIG. 5D illustrates such a method 530 including taste fingerprinting a user in step 532 and using the taste fingerprint of the user in step 534.

Various embodiments may include providing a kit for taste testing, which contains samples that mark out the taste-space axes (as in marking different distinct sets of color, palette, fruitiness, aroma, sweetness, etc., amongst the N parameters of taste for the spirits or beverage). Then, the user of the kit scores the tastes of these samples and provides feedback. Then, using this data, the following outcomes are derived: a) A fingerprint of the user's taste profile is determined; b) A set of recommendations for spirits to fit this profile may be provided; c) A rapid spirits maturing process recipe to best fit that taste profile may be provided; d) A network of restaurants may be informed of the user's taste profile such that they could provide the user with beverages to their liking; and e) The user could be provided with “challenge” tastes (as in tastes likely not quite to the user's liking but close enough such that the user could come to like those tastes). The kit for taste testing could be used for conducting business in a format which is similar to the genetic fingerprinting of 23-And-Me. In various embodiments, the rapid spirits maturing process is used in order to generate multiple product outputs from a single input feedstock of spirits and thus enabling the kit for taste testing (e.g., the 23-And-Me business model) above to be very cost effective without requiring sourcing supplies of multiple tastes of spirits.

Various embodiments may include creating a Pantone Color model where the axes of the N dimensions of the taste of the spirits or beverages are mapped to a color wheel or wheels such that colors may be used to denote taste preferences in short-hand and to be deterministic of taste profile with an easy way for communication. Mapping the taste space to colors creates an easy to understand arrangement for the advantage of marketing the concept of customization of tastes and flavors. In various embodiments, rapid spirits maturing processes may be used in order to generate multiple product outputs from a single input feedstock of spirits and thus enabling the Pantone Color embodiments to be very cost effective without requiring the sourcing of supplies of multiple tastes of spirits.

Various embodiments may provide the business model wherein a taste profile is determined through an on-line interface; a kit could be tested, a profile could be determined, and more product could be ordered to that taste profile. Various embodiments may include using rapid spirits maturing processes to in order to generate multiple product outputs from a single input feedstock of spirits and thus enabling the kit invention above to be very cost effective without requiring the sourcing of supplies of multiple tastes of spirits.

Various embodiments may enable the determination of the repeatability of a taster for a given taste response parameter by conducting a design of experiments activity with a produced set of micro-samples that accentuate the axes of taste and then score the signal-to-noise and repeatability of a given taster person in regards to these taste parameters. Various embodiments include the method of using this data set to then create tastes and flavors that will be graded highly by those tasting persons. In various embodiments, the method may include providing this data set as feedback to the taster person such that they can understand their strengths, and then also creating a program of providing tasting samples that would allow the tasting person to practice and train in the axes of taste space where their signal-to-noise or repeatability has been shown to be limited. Various embodiments include a database service that may be provided for tasters or for those procuring the service of tasters such that a taster's capability could be certified against certain tests with payment of a subscription for this service. Various embodiments include using various rapid spirits maturing processes in order to generate multiple product outputs from a single input feedstock of spirits and thus enabling the taster evaluation invention above to be very cost effective without requiring the sourcing of supplies of multiple tastes of spirits.

Various embodiments include providing an on-line selection of flavors, receiving a sample, entering feedback after tasting the sample, and updating the preferred flavor profile. Various embodiments include using rapid spirits maturing processes in order to generate multiple product outputs from a single input feedstock of spirits and thus enabling the on-line flavor selection and taste preference refining invention above to be very cost effective without requiring the sourcing of supplies of multiple tastes of spirits.

Various embodiments may include broad implementations of rapid spirits maturing processes.

Various embodiments may include structures and method for capture of the vapors from rapid spirits maturing processes including when the rapid spirits maturing processors' vessels are opened, for example via a filter, such as an activated carbon filter. The various embodiments include the post use consumption of this filter as fuel for power generation.

Various embodiments may be used in barrel-based or fermentation-based rapid spirits maturing processes and products. FIG. 5D illustrates such a method 540 including using a rapid spirits maturing processor (e.g., the rapid spirits maturing processors 100, 130, 202, the maturation units 350, 370, and/or the beverage dispensing system 400, etc.) for flavoring, aging, creating, and/or refining any typical barrel-based and/or fermentation based product in a step 542.

Various embodiments may include using rapid spirits maturing process to create a barrel aged taste in other products where mass manufacturing is often in steel vessels, but best tasting product is created in wooden barrels. For example, soy sauce taste is improved by adding flavor with the addition of charred, un-toasted, and/or toasted micro-staves. In this case, the micro-staves could be bamboo-related instead of oak-related. For example, balsamic vinegar taste is improved by adding flavor with the addition of un-toasted, charred, and/or toasted micro-staves. In this case, a cocktail of wooden micro-staves could be used to create the rapid maturation equivalent of the cascade of barrels that are typically used in the classic balsamic vinegar process.

Various embodiments enable rapid maturing of non-spirits products that are typically aged in barrels or rapid creation of non-spirits products that require fermentation. For example, using micro-staves of bamboo, rather than the fermentation and aging process normally used in soy sauce, a soy sauce rapid maturing process may be conducted in a rapid maturing processor that is a device, system, or structure including a vessel (or container), such as a steel vessel, in which soy sauce is rapidly fermented, aged, and flavored by using micro-staves and controlled temperature, pressure, air, etc. For example, balsamic vinegar may be improved in flavor by using a rapid maturing processor that is a device, system, or structure including a vessel (or container), such as a steel vessel, in which balsamic vinegar is rapidly matured and flavored by using micro-staves and controlled temperature, pressure, air, etc.

Similarly, various embodiments include the processing of an array of barrel-aged products using the addition of charred, un-toasted, and/or toasted micro-staves, including soy sauce, vinegar, olive oil, flavored water, BBQ sauce, hot sauce, syrup, tequila, sake, soju, baijiu, etc. For example, such typically barrel-aged products (whether spirits products or non-spirits products) may be improved in flavor, aged, created, and/or otherwise refined by using a rapid maturing processor that is a device, system, or structure including a vessel (or container), such as a steel vessel, in which typically barrel-aged products (e.g., soy sauce, vinegar, olive oil, flavored water, BBQ sauce, hot sauce, syrup, tequila, sake, soju, baijiu, etc.) may be rapidly flavored, aged, created, and/or otherwise refined by using micro-staves and controlled temperature, pressure, air, and/or other process variables.

Various embodiments include driving flavors into alcoholic beverages or food items which are typically aged in barrels using rapid maturation processes wherein the micro-staves of the process could be pre-treated with flavoring items such as ethyl acetate or other fruit flavor or vanilla flavor compounds. This process could be used to create various flavored products, such as flavored wine, flavored beer, flavored spirits, flavored vinegar, flavored olive oil, etc.

Various embodiments may include using rapid spirits maturing processes to generate low alcohol whiskey product equivalents.

Various examples, such as Examples A-N, are provided to illustrate aspects of the various embodiments. Example A: A method, comprising creating a dispersion of spirit flavors from a single input batch of spirits. Example B: A method, comprising reusing micro-staves already used in rapid spirits maturing for non-rapid spirits maturing purposes. Example C: A method, comprising using rapid spirits maturing to upgrade spirits to a higher value spirits or better marketability spirits. Example D: A method for taste fingerprinting of a user. Example E: The method of Example D, comprising using the taste fingerprint of the user. Example E: A method comprising using a rapid spirits maturing processor in a distillery. Example F: A method comprising using a rapid spirits maturing processor on a farm. Example G: A method comprising using a rapid maturing processor for flavoring, aging, creating, and/or refining any typically barrel-based and/or fermentation-based product. Example H: The method of Example G, wherein the product is a barrel-based and/or fermentation-based product is a spirits product or non-spirits product. Example I: A mobile rapid spirits maturing processor. Example J: A capsule including a spirits concentrate that when blended with a liquid creates a desired end product. Example K: The capsule of Example J, wherein the liquid is water or alcohol. Example L: A wood concentrate that when diluted with water or neutral spirits produces a flavored spirit. Example M: A beverage dispensing system in which water or neutral spirits is diluted through a wood concentrate to output flavored spirits. Example N: A maturation unit designed for onsite use, for example in hotels, in bars, at home.

Various aspects illustrated and described are provided merely as examples to illustrate various features of the claims. However, features shown and described with respect to any given aspect are not necessarily limited to the associated aspect and may be used or combined with other aspects that are shown and described. Further, the claims are not intended to be limited by any one example aspect.

In an embodiment, the functions of one or more controllers of a rapid spirits maturing processor (e.g., rapid spirits maturing processors 100, 130, 202, the maturation units 350, 370, and/or the beverage dispensing system 400) may be implemented in software, hardware, firmware, on any combination of the foregoing. In an embodiment, the hardware may include circuitry designed for implementing the specific functions of the one or more controllers of the rapid spirits maturing processor. In an embodiment, the hardware may include a programmable processing device configured with instructions to implement the functions of the one or more controllers of the rapid spirits maturing processor.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc. are not intended to limit the order of the steps; these words are simply used to guide the reader through the description of the methods.

One or more block/flow diagrams have been used to describe exemplary embodiments. The use of block/flow diagrams is not meant to be limiting with respect to the order of operations performed. The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

Control elements may be implemented using computing devices (such as computer) comprising processors, memory and other components that have been programmed with instructions to perform specific functions or may be implemented in processors designed to perform the specified functions. A processor may be any programmable microprocessor, microcomputer or multiple processor chip or chips that can be configured by software instructions (applications) to perform a variety of functions, including the functions of the various embodiments described herein. In some computing devices, multiple processors may be provided. Typically, software applications may be stored in the internal memory before they are accessed and loaded into the processor. In some computing devices, the processor may include internal memory sufficient to store the application software instructions.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

The preceding description of the disclosed embodiments is provided to enable any person skilled in the art to make or use the described embodiment. Various modifications to these embodiments will be readily apparent to those skilled in the art, and the generic principles defined herein may be applied to other embodiments without departing from the scope of the disclosure. Thus, the present invention is not intended to be limited to the embodiments shown herein but is to be accorded the widest scope consistent with the following claims and the principles and novel features disclosed herein.

1. A method for producing spirits, comprising:
providing a single input batch of spirits; and
producing spirit products having a dispersion of spirit flavors from the single input batch of spirits.

2. The method of claim 1, wherein at least one of the spirit products is produced via rapid-sprits maturing using micro-staves, the method further comprising reusing the micro-staves already used in rapid spirits maturing for non-rapid spirits maturing purposes.

3. The method of claim 1, wherein producing the spirit products comprises using rapid spirits maturing to upgrade spirits to a higher value spirits or better marketability spirits.

4. The method of claim 1, further comprising performing taste fingerprinting of a user.

5. The method of claim 4, comprising using the taste fingerprint of the user to produce a spirit product.

6. The method of claim 1, wherein the spirit products are produced using a rapid spirits maturing processor in a distillery.

7. The method of claim 1, wherein the spirit products are produced using a rapid spirits maturing processor on a farm.

8. The method of claim 1, wherein the spirit products are produced using a rapid maturing processor for flavoring, aging, creating, and/or refining any typically barrel-based and/or fermentation-based product.

9. (canceled)

10. The method of claim 1, wherein at least one spirit product is produced using a mobile rapid spirits maturing processor.

11. The method of claim 1, wherein at least one spirit product is produced using a capsule including a spirits concentrate that when blended with a liquid creates a desired end product.

12. The capsule of claim 11, wherein the liquid is water or alcohol.

13. The method of claim 1, wherein at least one spirit product is produced using a wood concentrate that when diluted with water or neutral spirits produces a flavored spirit.

14. The method of claim 1, wherein at least one spirit product is produced using a beverage dispensing system in which water or neutral spirits is diluted through a wood concentrate to output flavored spirits.

15. (canceled)

16. A rapid spirits manufacturing processor configured to perform the method of claim 1.
